(19) United States
(12) Patent Application Publication
(10) Pub. No.: US 2022/0378067 A1
(43) Pub. Date: Dec. 1, 2022

(54) METHOD FOR MANUFACTURING EASY-TO-COOK AND EASY-TO-BREW NOODLES

(71) Applicant: A-SHA REPUBLIC INC., TAIPEI CITY (TW)

(72) Inventor: TA-WEI LO, TAIPEI CITY (TW)

(21) Appl. No.: 17/330,424

(22) Filed: May 26, 2021

(51) Int. Cl. A23L 7/109

(52) U.S. Cl. CPC A23L 7/109

(57) ABSTRACT

An method for manufacturing easy-to-cook and easy-to-brew noodles includes the following steps: mixing an appropriate amount of semolina or durum wheat flour with an appropriate amount of water and an appropriate amount of salt; forming a mixture of the semolina or durum wheat flour, water and salt into thin strips, spirals, sheets or other different shapes of noodles; steaming the formed noodles; cutting the steamed noodle quantitatively; and making instant pasta by carrying out semi-puff drying or full-puff drying on the steamed and quantitatively cut noodles according to the thickness or set brewing time, thereby allowing the pasta to be brewed or cooked in a short time, and fast edible.

### (a) TECHNICAL FIELD OF THE INVENTION

The present invention relates to a method for manufacturing easy-to-cook and easy-to-brew noodles, and more particularly to a method for manufacturing easy-to-cook and easy-to-brew noodles, making pasta ready for brewing or short-time cooking, and fast edible.

### (b) DESCRIPTION OF THE PRIOR ART

Pasta generally refers to all kinds of noodles from Italy; in Italy, “pasta” is generally used to refer to various noodles made of flour, water, and sometimes eggs. In a narrow sense, pasta is made from durum wheat flour or semolina, and in a broad sense, it can include other grains as raw materials. The characteristic of pasta is that there are many different types, such as long and moderately thick spaghetti, thicker and flat Italian linguine, thinner angel hair, twisted fusilli, and many other kinds. In addition to Italy and Europe, pasta also has a high degree of popularity all over the world, and is favored by consumers. However, pasta must be cooked in water for a longer time (usually 8 to 13 minutes) because it is not easy to absorb water, and the cooked pasta tastes hard.

Instant noodles popular in Asia countries and regions are noodles that can be cooked or brewed in a short period of time. The principle of instant noodles is to harden cooked and seasoned noodles and press them into blocks, and the noodle blocks are brewed or simply cooked in hot water before eating; noodles are soaked to soften in hot water, they can be eaten in a few minutes, where the noodles for quick cooking are made of water, salt, appropriate formula and flour; the noodles for brewing are made of water, salt, appropriate starch and formula plus flour. Therefore, if pasta wants to be made into instant noodles that can be quickly cooked or brewed, it will not be possible based on the basic structure and ingredients of pasta.

### SUMMARY OF THE INVENTION

To integrate the manufacturing process of instant noodles with the characteristics of pasta, and to make pasta quickly cooked and ready to be brewed and eaten, the present invention is proposed.

The main object of the present invention is to provide a method for manufacturing easy-to-cook and easy-to-brew noodles, allowing pasta to be brewed or cooked in a short time, and fast edible.

To achieve the above object, the present invention proposes a method for manufacturing easy-to-cook and easy-to-brew noodles, including the following steps: mixing an appropriate amount of semolina or durum wheat flour with an appropriate amount of water and an appropriate amount of salt; forming a mixture of the semolina or durum wheat flour, water and salt into thin strips, spirals, sheets or other different shapes of noodles; steaming the formed noodles; cutting the steamed noodle quantitatively; and making instant pasta by carrying out semi-puff drying or full-puff drying on the steamed and quantitatively cut noodles according to the thickness or set brewing time, thereby allowing the pasta to be brewed or cooked in a short time, and fast edible.

According to the above method of the present invention, the semolina or durum wheat flour is about 77% by weight, the water is about 21% to 22% by weight, and the salt is about 1% to 2% by weight.

According to the above method of the present invention, the formed noodles are steamed completely.

According to the above method of the present invention, the semi-puff drying is carried out at a temperature of about 120° C. to 150° C.

According to the above method of the present invention, the full-puff drying is carried out at a temperature of about 150° C. to 200° C.

### BRIEF DESCRIPTION OF THE DRAWINGS

FIG. 1 is a manufacturing flow chart of a preferred embodiment of the present invention;

FIG. 2 is a detailed flow chart of Step S12 of the present invention;

FIG. 3 shows a noodle before semi-puff drying according to the present invention;

FIG. 4 shows the noodle after semi-puff drying according to the present invention;

FIG. 5 is a manufacturing flow chart of another preferred embodiment of the present invention;

FIG. 6 is a detailed flow chart of Step S22 of the present invention;

FIG. 7 shows a noodle before full-puff drying according to the present invention; and

FIG. 8 shows the noodle after full-puff drying according to the present invention;

### DETAILED DESCRIPTION OF THE PREFERRED EMBODIMENTS

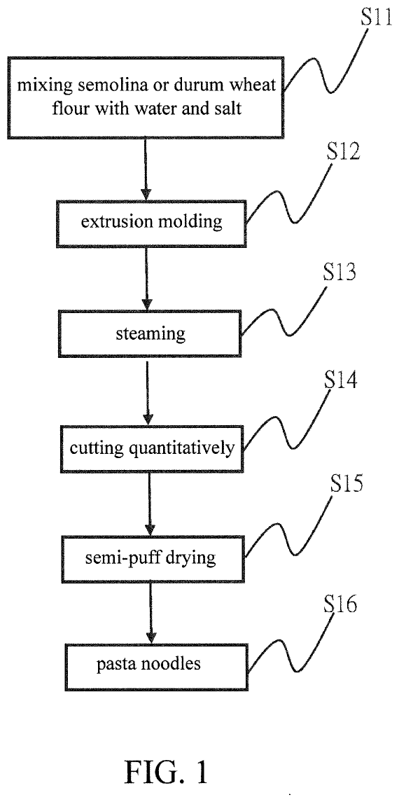

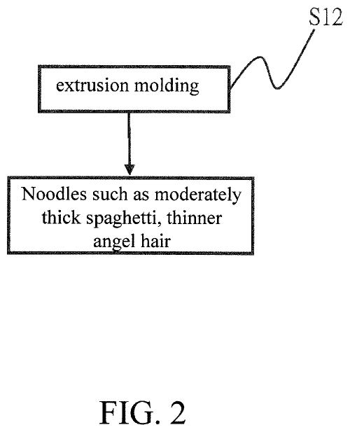

Referring to FIGS. 1 and 2, a method for manufacturing easy-to-cook and easy-to brew noodles of a preferred embodiment according to the present invention includes the following steps:

1. mixing about 77% semolina or durum wheat flour with about 21%-22% water and about 1%-2% salt; in the embodiment, mixing approximately 100 kilograms of semolina or durum wheat flour, and approximately 30 kilograms of water and salt (step S11);

2. forming the mixture of the above semolina or durum wheat flour, water and salt into noodles by means of extrusion molding; in the embodiment, forming the mixture into long strips of moderately thick spaghetti, thinner angel hair and other noodles by means of extrusion molding with different molds (step 12);

3. steaming the formed noodles completely (step 13);

4. cutting the steamed noodles quantitatively (step 14);

5. drying the steamed and quantitatively cut noodles with semi-puff drying; in the embodiment, drying the steamed and quantitatively cut noodles with semi-puff drying at a temperature of about 120-150° C. (step 15); and

6. making pasta that is easy to cook and brew (step 16).

In the drying step of the above process, the drying way is decided according to the thickness of the noodle and the setting of the brewing time, so that semi-puff drying is chosen when making noodles such as moderately thick spaghetti and thin angel hair, make the noodle maintain in its original shape, and the capillary pores generated therein are small; water enters the noodle more slowly and the noodle will not be too soft when cooking.

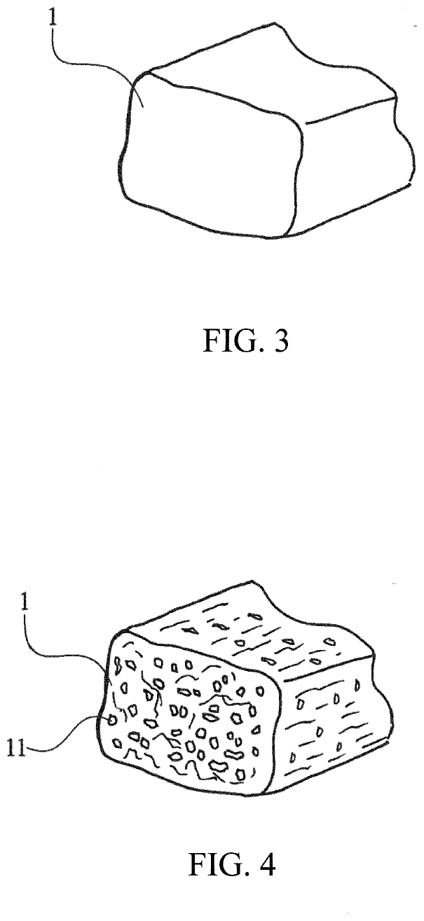

Referring to FIGS. 3 and 4, the noodle 1 of the present invention, as FIG. 3 shows, is smooth without any wrinkles and pores before the semi-puff drying, and the noodle 1, as FIG. 4 shows, can maintain in its original shape, but the longitudinal section of the noodle 1 will form a plurality of irregularly arranged small capillary pores 1 after the semi-puff drying. Since the diameters of the small capillary pores are smaller, water enters the noodles more slowly, and will not make the noodles too soft when cooking.

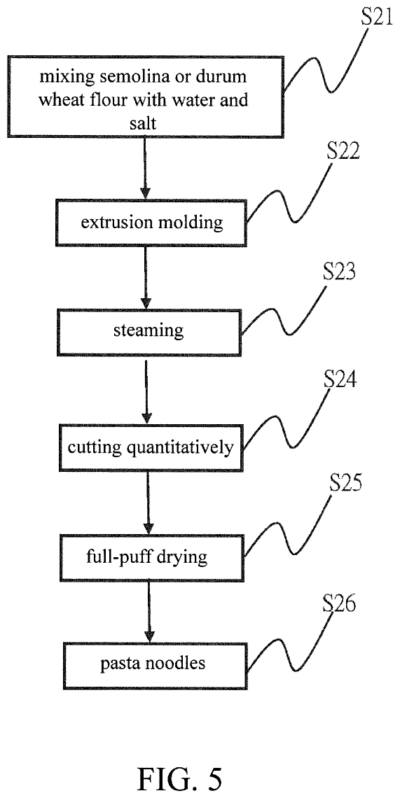

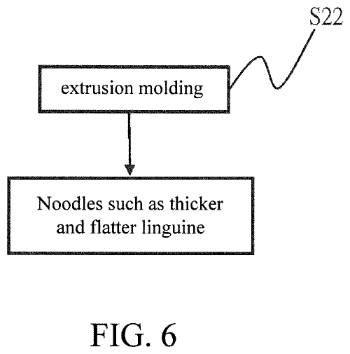

Referring to FIGS. 5 and 6, a method for manufacturing easy-to-cook and easy-to brew noodles of another preferred embodiment according to the present invention includes the following steps:

1. mixing about 77% semolina or durum wheat flour with about 21%-22% water and about 1%-2% salt; in the embodiment, mixing approximately 100 kilograms of semolina or durum wheat flour, and approximately 30 kilograms of water and salt (step S21);

2. forming the mixture of the above semolina or durum wheat flour, water and salt into noodles by means of extrusion molding; in the embodiment, forming the mixture into thick and flat noodles such as linguine by means of extrusion molding with different molds (step 22);

3. steaming the formed noodles completely (step 23);

4. cutting the steamed noodles quantitatively (step 24);

5. drying the steamed and quantitatively cut noodles with full-puff drying; in the embodiment, drying the steamed and quantitatively cut noodles with full-puff drying at a temperature of about 150-200° C. (step 25); and

6. making pasta that is easy to cook and brew (step 26).

In the drying step of the above process, the drying way is decided according to the thickness of the noodle and the setting of the brewing time, so that full-puff drying is chosen when making noodles such as thick and flat linguine, making the noodle become large after the puff; since the capillary pores are large and water enters the noodle more easily such that the noodle has better water absorption, the noodle will not be soft on the outside and hard on the inside due to insufficient cooking time, or soft on the inside and too soft on the outside due to too long cooking time when cooking.

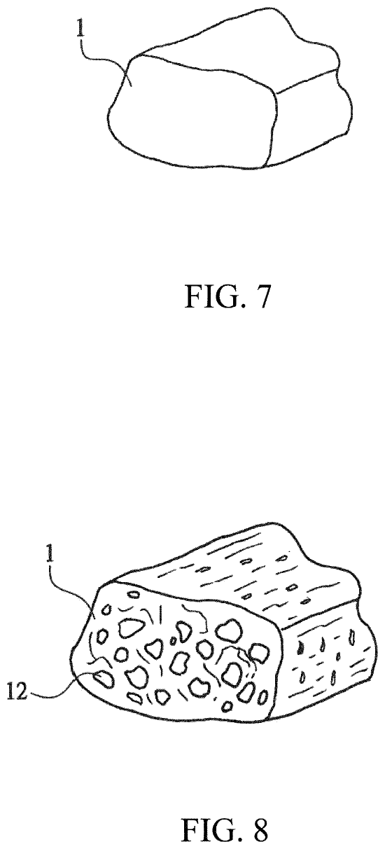

Referring to FIGS. 7 and 8, the noodle 1 of the present invention, as FIG. 7 shows, is smooth without any wrinkles and pores before the full-puff drying, and the noodle 1, as FIG. 8 shows, becomes large, and the longitudinal section of the noodle 1 will form a plurality of irregularly arranged large capillary pores 1 after the full-puff drying. Since the diameters of the large capillary pores 12 are greater, water enters the noodles more easily such that the noodle has better water absorption, and the noodle will not be soft on the outside and hard on the inside due to insufficient cooking time, or soil on the inside and too soft on the outside due to too long cooking time when cooking.

Conclusively, the present invention mixes semolina or durum wheat flour with water and salt, and then forms the mixture into noodles by means of extrusion molding. Thereafter, according to the thickness of the noodles or the set brewing time thereof, the noodles are carried out with semi-puff drying or full-puff drying, and the process of instant noodles is integrated with the characteristics of pasta to make instant pasta, so that the pasta can be brewed or cooked in a short time, and fast edible.

I claim:

1. A method for manufacturing easy-to-cook and easy-to-brew noodles, comprising the following steps:
mixing semolina or durum wheat flour with water and an appropriate amount of salt;
forming a mixture of said semolina or durum wheat flour, water and salt into moderately thick or thinner noodles;
steaming said formed noodles;
cutting said steamed noodle quantitatively; and
making said easy-to-cook and easy-to-brew pasta by carrying out semi-puff drying on said steamed and quantitatively cut noodles.

2. The method according to claim 1, wherein, in said step of mixing, said semolina or durum wheat flour is about 77% by weight, said water is about 21% to 22% by weight, and said salt is about 1% to 2% by weight.

3. The method according to claim 1, wherein, in said step of steaming, said formed noodles are steamed completely.

4. The method according to claim 1, wherein, in said step of semi-puff drying, said drying is carried out at a temperature of about 120° C. to 150° C.

5. A method for manufacturing easy-to-cook and easy-to-brew noodles, comprising the following steps:
mixing semolina or durum wheat flour with water and an appropriate amount of salt;
forming a mixture of said semolina or durum wheat flour, water and salt into thicker and flatter noodles;
steaming said formed noodles;
cutting said steamed noodle quantitatively; and
making said easy-to-cook and easy-to-brew pasta by carrying out full-puff drying on said steamed and quantitatively cut noodles.

6. The method according to claim 5, wherein, in said step of mixing, said semolina or durum wheat flour is about 77% by weight, said water is about 21% to 22% by weight, and said salt is about 1% to 2% by weight.

7. The method according to claim 5, wherein, in said step of steaming, said formed noodles are steamed completely.

8. The method according to claim 5, wherein, in said step of full-puff drying, said drying is carried out at a temperature of about 150° C. to 200° C.
